(19) United States
(12) Patent Application Publication
(10) Pub. No.: US 2020/0265667 A1
(43) Pub. Date: Aug. 20, 2020

(54) REAL TIME PARLAY

(71) Applicant: CFPH, LLC, New York, NY (US)

(72) Inventors: Lee AMAITIS, Las Vegas, NV (US); Andrew Garrood, London (GB)

(21) Appl. No.: 16/866,057

(22) Filed: May 4, 2020

Related U.S. Application Data
(63) Continuation of application No. 13/113,479, filed on May 23, 2011, now abandoned.
(60) Provisional application No. 61/347,638, filed on May 24, 2010.

(51) Int. Cl. G07F 17/32; G06Q 50/34

(52) U.S. Cl. CPC G07F 17/32; G06Q 50/34

(57) ABSTRACT

Various methods and apparatus related to parlay wagering are described. In some embodiments, real time parlay odds may be offered. Further embodiments are described.

### CROSS REFERENCE TO RELATED APPLICATION

This application is a continuation of U.S. patent application Ser. No. 13/113,479 filed May 23, 2011 which claims the benefit of U.S. Provisional Patent Application Ser. No. 61/347,638 filed on May 24, 2010, each of which are hereby incorporated by reference herein in their entireties.

### BRIEF DESCRIPTION OF THE FIGURES

FIG. 1 depicts an apparatus for playing a game, according to some embodiments;

FIG. 2 illustrates an example method that may be performed in some embodiments;

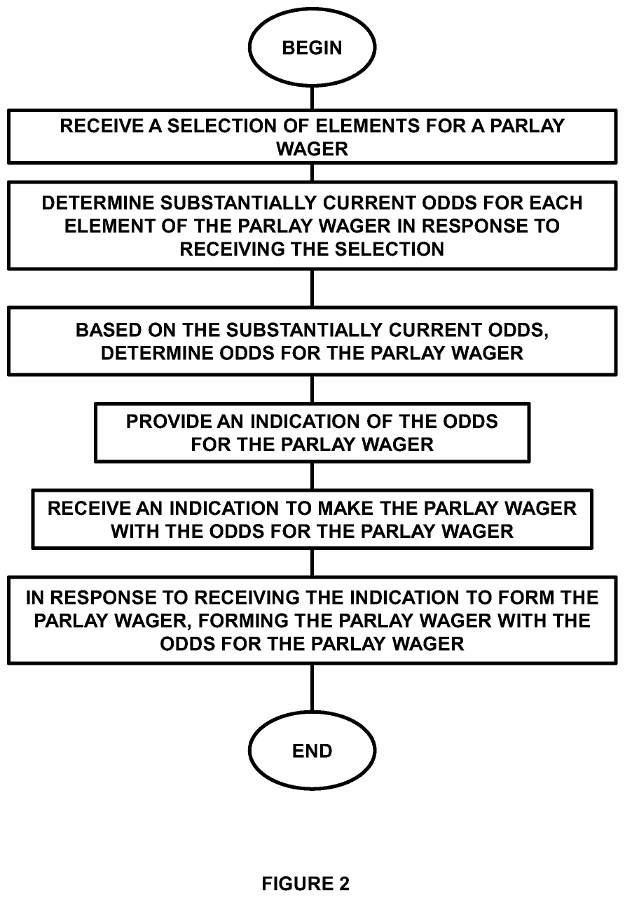

FIG. 3 illustrates an example method that may be performed in some embodiments; and

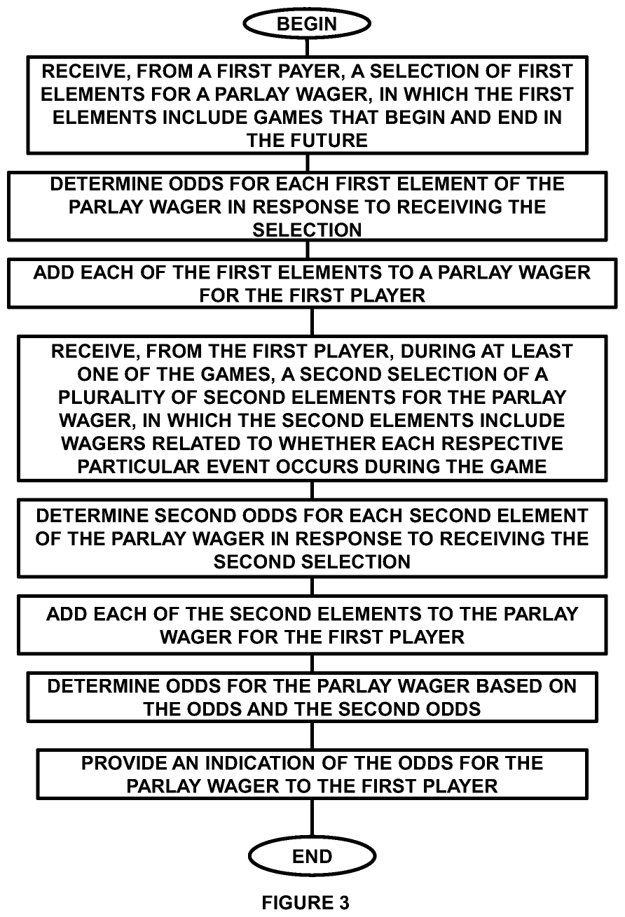

FIG. 4 illustrates an example method that may be performed in some embodiments.

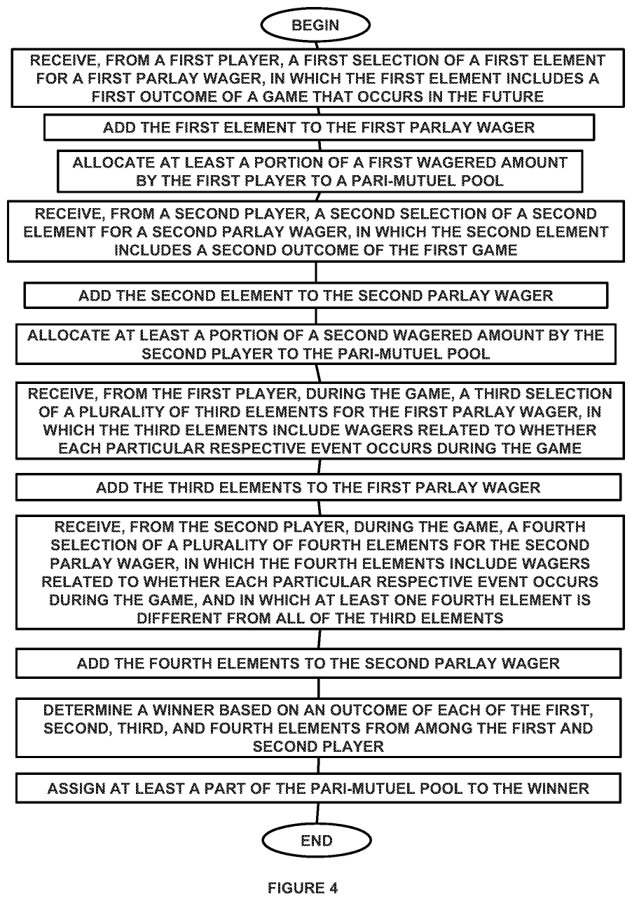

### DETAILED DESCRIPTION

The following sections I-X provide a guide to interpreting the present application.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of”, to be the only components of or to be the only members of, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. Disclosed Examples and Terminology are not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. § 1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth®, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. § 112, Paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### IX. Incorporation By Reference

Any patent, patent application or other document referred to herein is incorporated by reference into this patent application as part of the present disclosure, but only for purposes of written description and enablement in accordance with 35 U.S.C. § 112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### XI. Video Wagering Games

Video wagering games are set up to mimic a table game using adaptations of table games rules and cards.

In one version of video poker the player is allowed to inspect five cards randomly chosen by the computer. These cards are displayed on the video screen and the player chooses which cards, if any, that he or she wishes to hold. If the player wishes to hold all of the cards, i.e., stand, he or she presses a STAND button. If the player wishes to hold only some of the cards, he or she chooses the cards to be held by pressing HOLD keys located directly under each card displayed on the video screen. Pushing a DEAL button after choosing the HOLD cards automatically and simultaneously replaces the unchosen cards with additional cards which are randomly selected from the remainder of the deck. After the STAND button is pushed, or the cards are replaced, the final holding is evaluated by the game machine's computer and the player is awarded either play credits or a coin payout as determined from a payoff table. This payoff table is stored in the machine's computer memory and is also displayed on the machine's screen. Hands with higher poker values are awarded more credits or coins. Very rare poker hands are awarded payoffs of 800-to-1 or higher.

### XII. Apparatus for Playing Over a Communications System

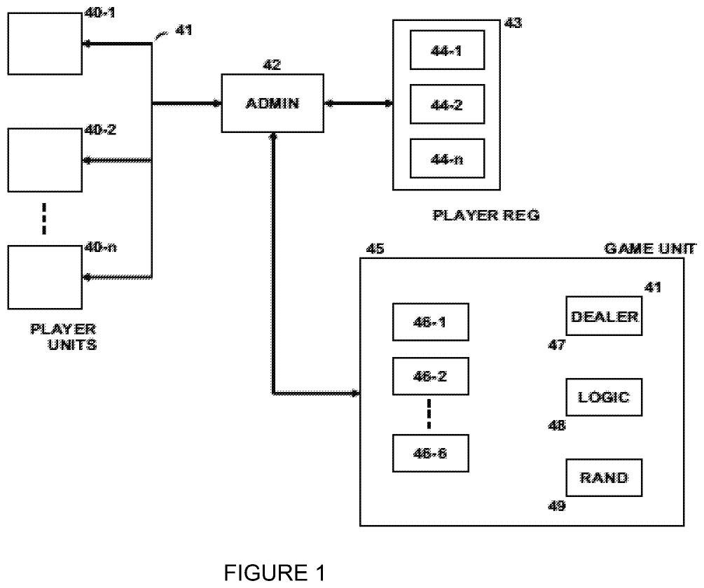

FIG. 1 shows apparatus for playing the game. There is a plurality of player units 40-1 to 40-n which are coupled via a communication system 41, such as the Internet, with a game playing system comprising an administration unit 42, a player register 43, and a game unit 45. Each unit 40 is typically a personal computer with a display unit and control means (a keyboard and a mouse).

When a player logs on to the game playing system, their unit 40 identifies itself to the administration unit. The system holds the details of the players in the register 43, which contains separate player register units 44-1 to 44-n for all the potential players, i.e., for all the members of the system.

Once the player has been identified, the player is assigned to a game unit 45. The game unit contains a set of player data units 46-1 to 46-6, a dealer unit 47, a control unit 48, and a random dealing unit 49.

Up to seven players can be assigned to the game unit 45. There can be several such units, as indicated, so that several games can be played at the same time if there are more than seven members of the system logged on at the same time. The assignment of a player unit 40 to a player data unit 46 may be arbitrary or random, depending on which player data units 46 and game units 45 are free. Each player data unit 46 is loaded from the corresponding player register unit 44 and also contains essentially the same details as the corresponding player unit 40, and is in communication with the player unit 40 to keep the contents of the player unit and player data unit updated with each other. In addition, the appropriate parts of the contents of the other player data units 46 and the dealer unit 47 are passed to the player unit 40 for display.

The logic unit 48 of the game unit 45 steps the game unit through the various stages of the play, initiating the dealer actions and awaiting the appropriate responses from the player units 40. The random dealing unit 49 deals cards essentially randomly to the dealer unit 47 and the player data units 46. At the end of the hand, the logic unit passes the results of the hand, i.e., the wins and/or losses, to the player data units 46 to inform the players of their results. The administrative unit 42 also takes those results and updates the player register units 44 accordingly.

The player units 40 are arranged to show a display. To identify the player, the player's position is highlighted. As play proceeds, so the player selects the various boxes, enters bets in them, and so on, and the results of those actions are displayed. As the cards are dealt, a series of overlapping card symbols is shown in the Bonus box. At the option of the player, the cards can be shown in a line below the box, and similarly for the card dealt to the dealer. At the end of the hand, a message is displayed informing the player of the results of their bets, i.e., the amounts won or lost.

### XIII. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

### XIV. References

The following patents and patent applications are hereby incorporated by reference herein for all purposes: U.S. Pat. Nos. 6,579,181, 6,299,536, 6,093,103, 5,941,769, 7,114,718, U.S. patent application Ser. No. 10/622,321, U.S. patent application Ser. No. 12/687,980, U.S. Pat. Nos. 4,515,367, 5,000,453, 7,137,630, and 7,137,629.

### XV. Sports

In some embodiments, some gambling systems enable users to bet on the outcome of a game and/or event within a game, e.g., which team will win, and/or by how much. Gaming operators try to determine accurate probabilities for each game outcome (e.g., win, loss, and point spread) so that they can offer competitive odds to potential bettors who may bet on each outcome. The probabilities (and odds) are typically determined prior to the start of the game based on information existing prior to the game, such as historical data related to each team, player, and coaching staff, ratings and opinions of professionals such as sportswriters and other coaches, and other public and proprietary information related to the game. For instance, some gaming operators use complicated proprietary computer algorithms to determine odds based on pre-existing statistical information and other information. The odds may change during a betting period as bettors wager on one side or another of an outcome (e.g., if many people wager that team A will win and few people wager that team B will win, the odds may become less favorable for a wager that team A will win).

In effect, odds are a gaming operator's “price” to bettors for wagering on a specific outcome (wherein higher odds translate to a lower price for the bettor). When there are a plurality of gaming operators offering odds on a particular outcome to a plurality of bettors, the gaming operators compete with one another to offer a competitive price that will attract bettors who seek the highest payout for their betting dollar. Thus, gaming operators may determine odds based in part on the odds offered by competing gaming operators. Betting behavior can also affect odds. For instance, a high demand for bets that the Chicago Cubs will win their next game against the Phillies may drive up the effective price for that bet. Accordingly, as in other competitive marketplaces, odds determinations often reflect a “market price” for each game outcome, as gaming operators adjust their odds based on the market. The effective market price can change over time as the betting market changes and new relevant information is disclosed, such as an injury of a key Cubs pitcher a day before the game. Notably, amounts wagered by losers on one side of the bet can be used to fund the payout to winners on the other side of the bet. Thus, in large betting markets where there are many bettors on each side of a bet, gaming operators may adjust their odds in an effort to balance the potential payouts on either side of the bet.

However, odds determinations often do not reflect a consensus “market price,” e.g., when there are a limited number of market participants or there is insufficient time for the market to assimilate new relevant information into a stable market price. For example, some gaming operators allow users to bet on performance parameters within a game, such as whether a particular player will strike out in a particular at-bat in a baseball game. The betting market is typically opened manually immediately prior to the in-game event, and the odds are often determined manually “on the fly.” Even if another gaming operator offered a similar bet, the quick timing of such a bet may prevent gaming operators and bettors from comparing the different odds offered. In these circumstances, the gaming operator may attempt to offer odds without the benefit of a competitive betting market based entirely on the operator's best assessment of the probabilities of the various outcomes.

It may take time and labor to identify a potential in-game betting market (e.g., a market for betting on the outcome of a specific at-bat), determine accurate probabilities and odds for each outcome, offer the odds to bettors, take bets, determine an outcome, and then pay the winners. Because some systems require many of these actions to be performed manually “on the fly,” limited manpower may effectively limits the number and extent of in-game wager opportunities a gaming operator can offer. Bets on an in-game event often require a calculation of probabilities and odds in a very short time frame. It can be more difficult to calculate an accurate probability of an in-game outcome when new relevant information becomes available during the game, such as an injury to a quarterback. Inaccurate odds can lead to unnecessarily high prices (and therefore fewer bettors) or unnecessarily low prices (which translates to unnecessarily high payouts to winners).

According to various embodiments, a system may enable users to bet on in-game events, such as whether a particular baseball player strikes out in a particular at-bat, and/or more traditional game outcomes, such as which team will win and/or by how much. The system may automatically receive general game information (e.g., team names, player rosters, start time, etc.) from a data feed or other source. From the same data source (or another source), the system may also automatically receive a stream of real-time game information, such as elapsed time, batting line-up, runs scored, errors on a play, pitch information (strike, ball, foul), etc.

Odds for each event, such as a strike-out, may be calculated based on an odds database and algorithm stored on the system. The algorithm may use information from the real sport (such as a player's batting average), and may be updated based on in-game events. (E.g., if Barry Bonds strikes out four times with the same pitcher, his odds of getting a hit off that pitcher may decrease.)

As soon as a specific gambling event is completed (e.g., as soon as Barry Bonds finishes his at-bat by striking out or hitting a home run), the system settles the bets placed on that betting event. At the same time (or another time), the system may open the betting for another event (e.g., the next at-bat). In one embodiment, a human operator clears the bets after each event. For example, the human gaming agent may select “strike out” immediately after Barry Bonds strikes out. This operation may cause the system to immediately settle all the bets on the present Barry Bonds at-bat and also open bets for the next betting event (e.g., the outcome of the next batter's at-bat). In other embodiments, the system may use automated information (e.g., a data feed) to determine event outcomes (like a strike-out) in real time. In some embodiments, human gaming agents may assist with error correction to ensure that the system identifies correct outcomes and resolves all bets properly.

Users may place bets and otherwise interact with the system and other users via an interface such as a gaming table or mobile touch-screen gaming device, which may be configured to display a live TV feed of an event such as a baseball game with an optional touch-sensitive betting interface overlay. In one embodiment, when Barry Bonds steps up to the plate, a user may touch the image of Barry Bonds (or other image or icon) to trigger the betting interface overlay that enables the user to select and place a specific bet concerning Barry's at-bat. To bet that Barry will get a single, the user may touch an image of first base (or provide another appropriate input). In some embodiments, a sports book, interactive kiosk, computer device, and/or any other desired method of wager formation may be used.

Various embodiments of the system may enable gambling on many different types of outcomes within a single game or other event, such as whether a particular runner steals a particular base, the number of runs scored in an inning, whether a pitcher throws a ball or strike on a given pitch, etc. The system may open and close each betting event based on the start and finish time of that particular event. The system can also be applied to a variety of sports as well as other events, such as elections (e.g., whether Barack Obama will win New Hampshire in the upcoming 2008 presidential election). It should be appreciated that various embodiments of the invention may manage many different betting markets at simultaneous or overlapping times. Each betting market may be opened, closed, and resolved based on the terms of that specific betting market, independently of other betting markets.

It should be recognized that various embodiments may include any type of wager, such as, for example, in-game wagers on sports or other events, wagers on outcomes of games or other events, and so on. It should be recognized that various embodiments may include any systems and/or methods for determining initial and/or future odds for any wager, such as, for example, an exchanged based system, a wager line set by a sports book algorithm and/or employee, and so on. It should be recognized that various embodiments may include any system and/or method for placing and/or managing wagers, such as, for example, a centralized computer system, a distributed computer system, one or more servers, one or more client computers, an in person system, a ticket system, a mobile system, and so on. Some examples of wager types, systems and methods for determining odds, and systems and methods for placing and managing wagers are described in U.S. patent application Ser. No. 12/258,297 to Storm and entitled Wager Market Creation and Management, which is hereby incorporated herein by reference.

Some embodiments may include wagers at a sports book or other venue for placing wagers on one or more competitions. Some example competitions on which a wager may be placed at a sports book may include auto racing, baseball, basketball, boxing, football, golf, hockey, and horse racing. Each competition type may have a different set of odds associated therewith.

In auto racing for example a sports book may list some number of individual drivers and/or a field (all other) option. Each individual driver and/or the field may be associated with some odds for each type of bet. For example, Jeff Gordon may be listed at 4-1, Jeff Burton at 15-1, Casey Atwood at 100-1, etc. If you bet $10 on Burton 15-1 and he goes on to win the race, you win $150 plus your $10 back, for a total payoff of $160. Matchup wagers may be available in which two or more drivers are paired against each other in a head-to-head wager. Odds for such a wager may also be provided. For example, a matchup may pit Dale Jarrett (minus 145) against Bobby Labonte (plus 125). If you bet $145 on the favored Jarrett, the payoff would be $100 plus your $145 back, for a total of $245. If you bet $100 on the underdog Labonte, the payoff would be $125 plus your $100 back, for a total of $225. Various other wagers may also be available such as, for example, an over/under on a number of cautions in a race, a car manufacturer that will win the race, in-game wagers, and so on.

In baseball for example, a sports book may list each team matchup with an odds associated with each team of each matchup. If a team on which a wager is placed wins a matchup, the payout to the winner may vary according to the odds. In some embodiments, baseball odds are shown using a money line.

In a money line, odds may be based on some dollar value (e.g., $1). In a money line, A “minus” preceding a number indicates the team is a favorite. A “plus” preceding a number indicates the team is an underdog. For example, if the Braves' odds are −120, this may mean that a $12 bet would win $10, for a return of $22. As another example, if the Dodgers' odds are +110, this may mean that a $10 bet would win $11, for a return of $21. Various types of money lines exist, such as dime lines and 20-cent lines and may be used in various embodiments. Some embodiments may not list a price for an underdog in a matchup but may instead use a house line for underdogs. Some embodiments may includes various other wagers, such as, for example, an over under on a total runs scored, a run line, a parlay in which a bettor may select multiple teams to win, in-game wagers, and so on.

Money lines may change as wagering proceeds. In some embodiments, an odds determined by the money line at the time of a wager may be the odds used to payout a wager at the end of a wager. In some embodiments, the money line at the end of a wagering period may be used to determine the odds of wager even if the money line was different when the wager was placed.

In basketball, for example, a sports book may operate similar to baseball. In some embodiments, a point spread may be used so that a bet on a team to win will win only if the team wins by the point spread. In some embodiments, the odds may be the same for all wagers, but the point spread may be changed. For example, a point spread may increase as more bettors wager on a team to win, similar to a change in the odds discussed above with respect to baseball. Some embodiments may allow “teasing” of a point spread (i.e., changing the point spread) in exchange for a change to the odds. Various other wagers may be includes in some embodiments, such as parlays, over under on point totals, in game wagers, and so on.

In boxing, for example, a sports book may operate a money line similar to a baseball money line described above. In hockey and football, for example, a sports book may operate a money line similar to a basketball money line described above.

In golf, for example, a sports book may operate a wagering method and/or system similar to auto racing described above. For example, a sports book may list a number of individual golfers and a field. Each option may be associated with an odds for each type of bet (e.g., to win a tournament). For example, Tiger Woods may be listed at 2-1, Tom Lehman at 25-1, Bob May at 100-1, etc. If you bet $10 on Lehman at 25-1 and he goes on to win the tournament, you win $250 plus your $10 back, for a total payoff of $260. A sports book may also include matchup propositions between two or more golfers. In some embodiments, one golfer may be matched against two or more golfers in such a proposition. Various other wagers may be included in some embodiments, such as over under on the winning score, over under on the lowest round by any golfer, over under on a finishing position of a golfer, in-game wagers, and so on.

In horse racing, for example, a sports book may provide a wide array of betting options. For example, a win, place, show, across the board, exacta, quinella, trifecta, superfecta, daily double, pick six, and so on wagering options may be available as well as any in-game wagers. Each wager option may be associated with a money line such as those described above or other type of odds system.

As discussed above, some embodiments may include various events or propositions that may be wagered upon, such as outcomes of an election, winnings of an award, and so on. Some embodiments may include wagers on an outcome of a season of a game, a season of a television show (e.g., Survivor), and so on. Some embodiments may include wagers on other casino games (e.g., craps, blackjack, slots, poker). Such bets may include bets on individual games, bets on other people, bets on statistics of the games, bets on tournaments of such games, and so on. It should be recognized that the examples of various wager types and odds types are given as non-limiting examples only and that various embodiments may include any desired wager types and/or odds types.

### XVII. Example Embodiments

Some embodiments may include a parlay wager. A parlay wager may include a wager on a plurality of games, a plurality of game participants, and/or a plurality of events. Such games, events, and/or teams may be referred to as elements of a parlay wager.

In some embodiments, a parlay wager may be won if all elements are winning elements (e.g., if all teams are winning teams in respective games). In some embodiments, a parlay wager may be a losing wager if any one element is a losing element. In some embodiments, any number of winning elements may be required to be winning elements for a parlay wager to be a winning wager. In some embodiments, any number of elements may need to be losing wagers for a parlay wager to be a losing wager. For example, a parlay wager may be a losing wager if there are more losing elements than winning elements. In some embodiments, a determination of whether a parlay wager is a winning wager or a losing wager may be made based on a comparison of the parlay wager to other parlay wagers. For example, a parlay wager with a highest percentage of winning elements may be a winning parlay wager, a parlay wager with a lowest number of losing elements may be a winning parlay wager, a parlay wager with a highest value of won elements in view of each elements odds may be a winning wager (e.g., sum of (1/chance of winning an element) times (1 for win or 0 for loss of that element)), and so on. In some embodiments, such a comparison may take place among a set of players (e.g., members that enter into a parlay tournament, based on a parlay pari-mutuel competition, for a particular week of games, and so on). A winner may earn an award (e.g., a pari-mutuel pool, a monetary award, an amount based on odds and wager amount, and so on).

In some embodiments, a tied element may count as a loss. In some embodiments, a tied element may count as a win. In some embodiments, a tied element may result in a push. In some embodiments, if an element of a parlay wager ties, the parlay wager may be separated into separate wagers and the tied element may push. In some embodiments, if an element of a parlay wager ties, that element may be removed from the parlay wager and the remaining elements may act as a parlay wager without that element. In some embodiments, such rules as desired may apply similarly and/or differently to canceled, and/or delayed elements.

In some embodiments, a player may win an award (e.g., a monetary payout) for winning a parlay wager. A player may win less of an award if some elements of a parlay wager are losing elements. A player may win more of an award for more winning elements of a parlay wager. In some embodiments, a player may only win the award if all elements of the parlay wager are winning elements. In some embodiments, there may be some maximum number and/or percentage of losing elements allowed for a player to win an award for a parlay wager. The amount of a payout may be based on an amount wagered. The amount of the payout may be based on the number of winning elements. The amount of the payout may be based on the number of losing elements. The amount of the payout may be based on the number of tied elements. The amount of the payout may be based on the number of elements. The amount of the payout may be based on the odds of each element. The amount of the payout may be determined in any manner desired. In some embodiments, an amount won may include an amount based on pari-mutuel pool. For example, players that place parlay wagers during a particular week, for a particular game, in a particular tournament, and/or in any common manner may have those wagers entered into a common pari-mutuel pool. One or more winners of such parlay wagers may be awarded winnings from the common pari-mutuel pool.

Some example payouts that may be used in some embodiments may include a 2 element parlay may pay 13 to 5, a 3 element parlay may pay 6 to 1, a 4 element parlay may pay 10 to 1, a 5 element parlay may pay 20 to 1, a 6 element parlay may pay 40 to 1, a 7 element parlay may pay 75 to 1, a 8 element parlay may pay 100 to 1, a 9 element parlay may pay 150 to 1, a 10 element parlay may pay 300 to 1, a 11 element parlay may pay 450 to 1, a 12 element parlay may pay 600 to 1, a 13 element parlay may pay 750 to 1, a 14 element parlay may pay 900 to 1, and a 15 element parlay may pay 1500 to 1. Such numbers are given as non-limiting examples only.

Some embodiments may include requirements for making a parlay wager. For example, in some embodiments, a maximum amount may be wager, a maximum amount may be won, a minimum amount may be wagered, a maximum number of elements may be included, a minimum number of elements may be included, and so on. In some embodiments, in order to qualify for a pari-mutuel pool and/or a jackpot wager of any sort, a player may be required to meet one or more criteria of wagers. For example, a player may be required to make wagers that have no more than and/or no less than a particular estimated chance of winning, may be required to make a particular monetary wager, may be required to make a certain number of wager types (e.g., 4 game wagers and 4 in running wagers, 10 wagers on baseball, etc.), may be required to wager on a particular set of elements (e.g., wager on every football game being played in a week, wager on every in running wager offered in a game, wager on a number of in running wagers offered during a period of time, etc.), may be required to wager on a particular sport, and so on.

Some embodiments may include a parlay card and/or other parlay wagering interface. A parlay card may allow a player to place a parlay wager on a number of desired elements. A parlay card may include a listing of odds for a parlay wager. A parlay wagering interface may include a kiosk, a slot machine, a web interface, a smart phone app, and so on through which a player may enter information related to a parlay wager.

As discussed herein, odds and/or payouts for a parlay wager may be based on odds for one or more of the elements of the parlay wager. For example, if the odds of all elements of a parlay wager are long, then the odds of the parlay wager may be long and/or the payout may be high. As one specific example, a parlay wager made up of a money line of wager of −125 and a money line wager of +130 for a two elements of a parlay wager may result in a parlay wager that has a 314 dollar payout for a 100 dollar bet. It should be recognized that these examples are non-limiting and that various embodiments may include any manner of basing and/or not basing odds and/or payouts for a parlay wager on odds of elements of the parlay wager as desired. For example, a house edge, a expected house take, a balance of house risk and so on may be maintained by such odds and/or payout setting as desired.

In some embodiments, the odds and/or payouts of a parlay wager may include real-time and/or substantially real-time odds and/or payouts. For example, the odds and/or payouts may be updated based on current odds for each element of the wager. For example, as odds for a wager on an element change (e.g., based on events happening related to the wager such as injuries, other wagers, and so on), the odds for a parlay wager involving that element may change. As an example, if the odds for a team in a game become longer because, for example, an injury occurs to a player of the team, then the odds for a parlay wager that includes that team may become longer to reflect that change in the odds of the team winning the game. As another example, if a large amount of money is being wagered on one side of an event, the odds for the event may change to balance the wagering. Such a change to the odds may be reflected in any parlay wagers involving that event. Accordingly, in some embodiments, parlay wagers that reflect substantially current situations may be made as opposed to traditional parlay wagers that are made using a single set of odds that are published once weekly.

In some embodiments, once a parlay wager is made, odds for the parlay wager may be set at the time of the wager. In some embodiments, odds for a made parlay wager may be adjusted as events that affect the odds may occur. In some embodiments, the odds may be set at some point (e.g., the start of a game, the end of a wagering period, and so on).

In some embodiments, parlay wagers may include in game wagers, out of game wagers, and so on. Some such wagers may be placed during a game and/or larger event. Odds and/or payouts related to such parlay wagers may be updated as events within a game and/or larger event unfold.

Some embodiments may include providing an updated odds and/or payouts to a user. Such presenting may take place through a parlay wagering interface (e.g., through a kiosk, a slot machine, a computing device, a smart phone app, at a sports book, and/or any other apparatus). For example, in some embodiments, a computing device may allow a player to play slots games, and to place parlay wagers. Such a computing device may include a server based gaming machine. Such a computing device may include a slot machine. Such parlay wagers may be based on updated odds for such a wager rather than traditional once a week published parlay odds. Though such an interface, a player may place a parlay wager based on such updated odds and/or payouts, monitor events related to placed parlay wagers, and so on.

Some embodiments may include updating odds and/or payouts for a parlay wager in response to a player selecting elements to be added to the parlay wager (e.g., based on the odds of the added element). Some embodiments may include updating odds and/or payouts of a parlay wager in response to a change in odds related to an element of the wager. In some embodiments, odds and/or payouts may be updated upon, after, and/or before selection of elements for a parlay wager as desired. In some embodiments, odds and/or payouts may be updated upon, after, and/or before a wager is placed as desired. In some embodiments, odds and/or payouts may be updated periodically, continually, in response to an event, and so on as desired.

In some embodiments, odds of an element may be determined in any manner as desired. For example, odds of an element may be received from another source, odds of an element may be determined based on a modeling, odds of an element may be determined based on events, and so on. In some embodiments, odds of a parlay wager based on elements may be determined in any manner. For example, odds may be determined based on a modeling, based on a Bayesian calculation, based on a desired house edge, and so on.

In some embodiments, a central server may determine various odds and/or payouts and provide such information to a terminal and/or other computing device for display to a user. A wager may be placed through the computing device. Any separation of actions between a client and/or server may be used in various embodiments as desired and/or not at all.

As described herein, some embodiments may include one or more in running wagers, which may also be referred to as in game wagers. In some embodiments, such wagers may include wagers that may relate to an event in a game (e.g., who will score a next point, how far a team will move a ball in a possession, what type of point will be scored next, who will score more points in the next five minutes, who will catch the next pass, and so on). Such wagers may include wagers that are offered during play of the game rather than before a game as in typical wagers. Some such wagers may also be offered before the game. In some embodiments, a parlay wager may include one or more such in running elements. In some embodiments, a parlay wager may include any combination of game elements (e.g., elements that relate to a whole game) and in running elements as desired. Some embodiments may include in-running wagers, setting odds for such wagers (e.g., based on prior events, based on a number of possible outcomes, based on a modeling of events), determining which wagers to offer (e.g., based on prior demand, based on perceived demand, based on events in the game, based on possible events in the game), determining outcomes of such wagers (e.g., based on the wagers, based on events in the game), and so on. Some examples of such wagers that may be used in various embodiments are described in U.S. patent application Ser. No. 13/023,551, entitled “WAGERING ON EVENT OUTCOMES DURING THE EVENT,” filed Feb. 9, 2011, which is hereby incorporated herein by reference.

In some embodiments, a parlay wager may be part of a pari-mutuel event. In some embodiments, a plurality of parlay wagers may be placed related to a pari-mutuel event (e.g., as part of a common pari-mutuel pool). One or more winners may win part or all of the common pari-mutuel pool. In some embodiments, such a pari-mutuel event may include an in-running related pari-mutuel event, a game related pari-mutuel event, and/or a pari-mutuel event that includes in-running and/or game wagers in any combination.

For example, in some embodiments, a pari-mutuel parlay event may include an event that requires entrants to make a parlay wager with a number of in running elements, a number of full game elements, and/or any combination of in running and full game elements. A pari-mutuel event may include wagers for a particular time frame, event, set of events, and so on (e.g., during a particular game, during a particular weekend, during a particular season, and so on). For example, in some embodiments players may enter into a pari-mutuel event by making a parlay wager that qualifies. In some embodiments, such a parlay wager may be required to meet one or more criteria (e.g., include required elements, be for a particular event, be made by a particular time, include an amount of money, and so on). For example, in some embodiments, a parlay wager may require ten in running element to be placed during a particular game, a particular set of games, and so on. The ten elements may be particular elements, any ten elements (e.g., any ten of a larger set of elements offered during a game), and/or any combination of required and/or optional elements.

One or more winners of a pari-mutuel event may be determined based on results of one or more parlay wagers. Determining a winner of a parlay wager may take any desired form some of which are described herein. For example, in some embodiments, a winner may include a winner with a most number of wining elements, a least number of losing elements, a comparison of odds for elements and wins and losses for elements, and so on. Some embodiments may include assigning a portion of a pari-mutuel pool to each wagered that has a highest number of winning elements, a lowest number of losing wagers, a highest set of points based on a comparison of odds and wins and losses as desired. Any further players may be assigned winnings from such a pool in any manner as desired (e.g., a second place winning, and so on).

In some embodiments, separate pari-mutuel pools may be established for each game, each time frame, each season, each side of a game, and/or in any manner as desired. For example, one pool may be established for players that wager that the Chicago Bears will win a game against the Green Bay Packers on a particular weekend, and a separate pool may be established for players that wager that the Packers will win the game against the Bears. In some embodiments, a pool may relate to a particular game rather than sides, a particular weekend rather than game, a particular set of games, a season, a set of events, and so on.

In each pool, one or more winners may be determined based on in running wagers placed by the players and/or game wagers placed by the players. In some embodiments, a pool may relate to a particular game so that players that wagers on the game may qualify to enter the pool (e.g., if they place one or more element wagers, if they place a required number of wager elements, and so on). In some embodiments, a player may be required to win one or more elements to qualify to win a game. For example, in some embodiments, a player may be required to win a bet on an outcome of a game (e.g., must select the Bears or the Packers correctly) to qualify to win a pari-mutuel pool that may be related to a game (e.g., even if one player wins more elements than a second player, then the one player may still lose if they didn't select the correct game winner).

In some embodiments, a player may be required to include one or more elements in a parlay wager. In some embodiments, players in a pari-mutuel pool may be required to wager on each in running wager offered during a game, a season, a weekend, and so on. In some embodiments, a player may be required to wager on a particular number and/or minimum number of in running wagers. In some embodiments, a player may be shown a number of upcoming in running wagers remaining in a game so that the player may be able to judge when to make a wager or when not to make a wager to qualify for the pool. In some embodiments, such an upcoming number may include an estimate, a minimum number, and so on. In some embodiments, if a player does not make a minimum number, the player may not be qualified to win a pool, and/or may have any number of elements not fulfilled be counted as losses.

Some embodiment may include determining a particular characteristic for entry into a pari-mutuel pool, presenting such characteristics, receiving wagers that qualify, presenting in running wagers during a game, receiving in running wagers, determining outcomes of the wagers, determining winners of the pari-mutuel pool, and so on. Such actions may be performed by one or more computing devices, servers, mobile devices, and so on.

In some embodiments, odds for a parlay wager may be determined at one or more desired times. For example, odds for a parlay wager that includes game odds and/or in running odds may be determined in part at a time of the placement of each element wager. In some embodiments, the entire odds may be set at a time of a last element wager. In some embodiments, wagers for some element may be required to be placed before other element wagers even open for being placed (e.g. wagers for a game may close before wagers for in running events in the game begin). In such an example, odds for the game element may be set when wagers related to the game close and/or when the element bet is made and odds for the in running element may be set when the in running wagers are made and/or when the in running wager closes and/or opens.

Some embodiments may include a parlay event related to a horse race, other race, and/or other events that may occur in any location in any combination. For example, in some embodiments, a player may choose event that include races at any number of race tracks in any combination to include as elements in a parlay. Similarly a player may choose any type of event in any combination (e.g., an election, a horse race, an in running event) to be added to a parlay wager.

Some embodiments, may allow a player to select odds for a parlay wager and/or one or more characteristics of the parlay wager with and/or without selecting elements of the parlay wager. In some embodiments based on such odds and/or other characteristics, one or more elements of a parlay wager may be chosen to meet the odds and/or characteristics. For example, in some embodiment, a player may desire a 10 element parlay wager without in running elements that has odds of 100 to 1. Some embodiment may include choosing elements of the parlay wager so that the odds of the summed 10 chosen elements come to as close as possible to 100-1 based on current odds for available elements. In some embodiments, a player may set other characteristics, such as that the parlay includes a particular element (e.g., that the Bears win against the Packers, that the longest odds are 10 to 1, that no favorites are picked, and so on). It should be recognized that in various embodiments, a player may set any number of characteristics and have an embodiment choose one or more elements for a parlay wager to meet desired characteristics.

Different Elements in a Same Pari Pool.
Weight C.7. The apparatus of claim C.6, in which the instructions cause the computing device to:
   determine a weighing for each of the third and fourth elements based on odds of each element; and
   determining the winner based on the weighings such that the winner includes the player that has the highest total weight of winning elements.

### Figures

### XVIII. Embodiments

The following should be interpreted as embodiments, and not as claims.

A. An apparatus comprising: a non-transitory medium having stored thereon a plurality of instructions that when executed by a processor cause the computing device to: receive a selection of elements for a parlay wager; determine substantially current odds for each element of the parlay wager in response to receiving the selection; based on the substantially current odds, determine odds for the parlay wager; provide an indication of the odds for the parlay wager; receive an indication to make the parlay wager with the odds for the parlay wager; and in response to receiving the indication to form the parlay wager, forming the parlay wager with the odds for the parlay wager.

A.1 The apparatus of claim A, in which the instructions cause the computing device to: determine the outcomes of each of the elements of the parlay wager; and determine an outcome of the parlay wager based on the outcomes of each of the elements. A.2. The apparatus of claim A, further comprising the computing device.

B. An apparatus comprising: a non-transitory medium having stored thereon a plurality of instructions that when executed by a processor cause the computing device to: receive, from a first payer, a selection of first elements for a parlay wager, in which the first elements include games that begin and end in the future; determine odds for each first element of the parlay wager in response to receiving the selection; add each of the first elements to a parlay wager for the first player; receive, from the first player, during at least one of the games, a second selection of a plurality of second elements for the parlay wager, in which the second elements include wagers related to whether each respective particular event occurs during the game; determine second odds for each second element of the parlay wager in response to receiving the second selection; add each of the second elements to the parlay wager for the first player; determine odds for the parlay wager based on the odds and the second odds; and provide an indication of the odds for the parlay wager to the first player.

B.1 The apparatus of claim B, in which the instructions cause the computing device to: determine the outcomes of each of the elements of the parlay wager; and determine an outcome of the parlay wager based on the outcomes of each of the elements. B.2. The apparatus of claim B, further comprising the computing device. B.3. The apparatus of claim B, in which the instructions cause the computing device to: present opportunities to select each of the second elements and a plurality of additional elements to the first player during the game. B.4. The apparatus of claim B, in which at least one second element includes at least one of an identity of a player to score a next point in the game, a distance that a team will move a ball in a next possession, and an amount of point scored in a next point scoring. B.5. The apparatus of claim B, in which the odds for each first element are determined at a respective close of wagering for each respective game based on odds at the respective close of wagering.B.6. The apparatus of claim B, in which the instructions cause the computing device to: adjust the odds after receiving the selection based on happenings that occur after receiving the selection. B.6.1. The apparatus of claim B.6, in which the happenings include additional wagers related to the games.

C. An apparatus comprising: a non-transitory medium having stored thereon a plurality of instructions that when executed by a processor cause the computing device to: receive, from a first player, a first selection of a first element for a first parlay wager, in which the first element includes a first outcome of a game that occurs in the future; add the first element to the first parlay wager; allocate at least a portion of a first wagered amount by the first player to a pari-mutuel pool; receive, from a second player, a second selection of a second element for a second parlay wager, in which the second element includes a second outcome of the first game; add the second element to the second parlay wager; allocate at least a portion of a second wagered amount by the second player to the pari-mutuel pool; receive, from the first player, during the game, a third selection of a plurality of third elements for the first parlay wager, in which the third elements include wagers related to whether each particular respective event occurs during the game; add the third elements to the first parlay wager; receive, from the second player, during the game, a fourth selection of a plurality of fourth elements for the second parlay wager, in which the fourth elements include wagers related to whether each particular respective event occurs during the game, and in which at least one fourth element is different from all of the third elements; add the fourth elements to the second parlay wager; determine a winner based on an outcome of each of the first, second, third, and fourth elements from among the first and second player; and assign at least a part of the pari-mutuel pool to the winner.

C.1. The apparatus of claim C, in which the instructions cause the computing device to: determine that the first and second element are wagers for a same side of the game and in response to that said determination, allocating the at least the portion of the first wagered amount to the pari-mutuel pool and allocating the at least the portion of the second wagered amount to the pari-mutuel pool. C.2. The apparatus of claim C, in which the instructions cause the computing device to: determine that the first and second element are wagers for different sides of the game and in response to that said determination, allocating the at least the portion of the first wagered amount to the pari-mutuel pool and allocating the at least the portion of the second wagered amount to the pari-mutuel pool.

C.3. The apparatus of claim C, in which the instructions cause the computing device to: present each of a plurality of optional elements to each of the first and second players during the game and in which the third and fourth selections include respective selections of different subsets of the optional elements. C.4. The apparatus of claim C, in which the instructions cause the computing device to: determine that each of the third and fourth elements include a same number of elements. C.5. The apparatus of claim C, in which the instructions cause the computing device to: determine the winner based on which of the first and second parlay wagers includes the most number of winning elements.

C.6. The apparatus of claim C, in which the instructions cause the computing device to: determine the winner based on which of the first and second parlay wagers includes the least number of losing elements. C.6.1. The apparatus of claim C.6, in which the instructions cause the computing device to: determine that the third elements include fewer elements that the fourth elements; and count each number of elements that are fewer as losing elements. C.7. The apparatus of claim C.6, in which the instructions cause the computing device to: determine a weighing for each of the third and fourth elements based on odds of each element; and determining the winner based on the weighings such that the winner includes the player that has the highest total weight of winning elements. C.8. The apparatus of claim C, further comprising the computing device. C.9. The apparatus of claim C, in which at least one of the third and fourth elements includes at least one of an identity of a player to score a next point in the game, a distance that a team will move a ball in a next possession, and an amount of point scored in a next point scoring. C.10 The apparatus of claim C, in which the instructions cause the computing device to: determine the outcomes of each of the elements of the first and second parlay wagers.

1. (canceled)

2. An apparatus comprising:
a memory;
a display device;
a network interface;
at least one processor to:
display at least one live game on the display device;
store in the memory a selection of first elements for a parlay wager received via the network interface, in which the first elements include games that begin and end at a future time;
receive, via the network interface, real-time game data;
determine real-time odds for each first element of the parlay wager based at least partially on the real-time game data received via the network interface;
add each of the first elements to the parlay wager in the memory
detect, via the display device, selection of an image of a live game participant;
store in the memory a second selection of second elements for the parlay wager, in which the second elements include wagers on one or more future events related to the image selected on the display device that could occur during the game;
determine real-time second odds for each second element of the parlay wager based at least partially on the real-time game data received via the network interface;
add each of the second elements to the parlay wager in the memory;
determine odds for the parlay wager based on the real-time odds and the real-time second odds; and
provide an indication of the odds for the parlay wager.

3. The apparatus of claim 2, wherein the at least one processor is further configured to:
determine an outcome of each of the first elements and second elements of the parlay wager; and
determine an outcome of the parlay wager based on the outcomes of each of the elements.

4. The apparatus of claim 2, wherein the at least one processor is further configured to:
render each of the second elements and a plurality of additional elements during the at least one of the games on the display device.

5. The apparatus of claim 2, in which at least one second element includes at least one of:
an identity of a player to score a next point in the game,
a distance that a team will move a ball in a next possession, and
an amount of point scored in a next point scoring.

6. The apparatus of claim 2, in which the odds for each first element are determined at a respective close of wagering for each respective game based on odds at the respective close of wagering.

7. The apparatus of claim 2, wherein the at least one processor is further configured to:
receive updated real-time game data via the network interface regarding real-time odds of at least one of the first elements, in which the updated real-time game data is based on at least one event occurring after selection of the first elements; and
based on the updated real-time game data regarding the real-time odds of the at least one of the first elements, update the odds for the parlay wager.

8. The apparatus of claim 2, wherein the at least one processor is further configured to:
receive updated real-time game data regarding real-time second odds of at least one of the second elements, in which the updated real-time game data is based on at least one second event occurring after selection of the second elements; and
based on the updated real-time game data regarding the real-time odds of the at least one of the second elements, update the odds for the parlay wager.

9. The apparatus of claim 2, wherein the at least one processor is further configured to:
receive updated real-time game data regarding real-time odds of at least one of the first elements, in which the updated real-time game data is based on at least one event occurring after selection of the first elements;
receive updated real-time game data regarding real-time second odds of at least one of the second elements, in which the updated real-time game data is based on at least one second event occurring after selection of the second elements; and
based on the updated real-time game data regarding the real-time odds and the real-time second odds, update the odds for the parlay wager.

10. The apparatus of claim 2, in which at least one event includes at least one additional wager relating to the at least one of the games.

11. An apparatus comprising:
a memory;
a network interface;
a display device;
at least one processor to:
display at least one live game on the display device;
detect via the display device a selection of an image of a live game participant;
receive, a selection of elements for a parlay wager, in which the elements include one or more future events related to the selected image that could occur during the game;
store the parlay wager in the memory;
receive, via the network interface, real-time game data;
determine real-time odds for each element of the parlay wager based at least partially on the real-time game data received via the network interface;
add each of the elements to the parlay wager in the memory;
determine odds for the parlay wager based on the real-time odds;
receive updated real-time game data regarding real-time odds of at least one the elements;
based on the updated real-time game data regarding the real-time odds of the at least one of the elements, updating the odds for the parlay wager; and
provide an indication of the updated odds of the parlay wager.

12. The apparatus of claim 11, wherein the at least one processor is further configured to:
determine an outcome of each of the elements of the parlay wager; and
determine an outcome of the parlay wager based on the outcomes of each of the elements.

13. The apparatus of claim 11, wherein the at least one processor is further configured to render each of the elements and a plurality of additional elements on a display device during at least one of the games.

14. The apparatus of claim 11, in which the odds for each element are determined at a respective close of wagering for each respective game based on odds at the respective close of wagering.

15. A method comprising:
displaying, by at least one processor, at least one live game on a display device;
receiving, by he at least one processor, real-time game data via a network interface;
receiving, by the at least one processor, a selection of first elements via the network interface for a parlay wager, in which the first elements include games that begin and end at a future time;
determining, by the at least one processor, real-time odds for each first element of the parlay wager based at least partially on the real-time game data received via the network interface;
adding by the at least one processor each of the first elements to the parlay wager;
detecting, by the at least one processor, selection of an image on the display device of a live game participant;
receiving, by the at least one processor, during at least one of the games, a second selection of second elements for the parlay wager, in which the second elements include wagers on one or more future events related to the selected image that could occur during the game;
determining real-time second odds for each second element of the parlay wager based at least partially on the real-time game data received via the network interface;
adding, by the at least one processor, each of the second elements to the parlay wager;
determining, by the at least one processor, odds for the parlay wager based on the real-time odds and the real-time second odds; and
providing, by the at least one processor, an indication of the odds for the parlay wager.

16. The method of claim 15, further comprising:
determining, by the at least one processor, an outcome of each of the first elements and second elements of the parlay wager; and
determining, by the at least one processor, an outcome of the parlay wager based on the outcomes of each of the elements.

17. The method of claim 15, further comprising:
displaying, by the at least one processor, each of the second elements and a plurality of additional elements during the at least one of the games.

18. The method of claim 15, in which at least one-second element includes at least one of:
an identity of a player to score a next point in the game,
a distance that a team will move a ball in a next possession, and
an amount of point scored in a next point scoring.

19. The method of claim 15, in which the odds for each first element are determined at a respective close of wagering for each respective game based on odds at the respective close of wagering.

20. The method of claim 15, further comprising:
receiving, by the at least one processor, updated real-time game data regarding real-time odds of at least one of the first elements, in which the updated real-time game data is based on at least one event occurring after selection of the first elements; and
based on the updated real-time game data regarding the real-time odds of the at least one of the first elements, updating, by the at least one processor, the odds for the parlay wager.

21. The method of claim 15, further comprising:
receiving updated real-time game data regarding real-time second odds of at least one of the second elements, in which the updated real-time game data is based on at least one second event occurring after selection of the second elements; and
based on the updated real-time game data regarding the real-time odds of the at least one of the second elements, updating, by the at least one processor, the odds for the parlay wager.

22. The method of claim 15, further comprising:
receiving, by the processor, updated real-time game data regarding real-time odds of at least one of the first elements, in which the updated real-time game data is based on at least one event occurring after selection of the first elements;
receiving, by the processor, updated real-time game data regarding real-time second odds of at least one of the second elements, in which the updated real-time game data is based on at least one second event occurring after selection of the second elements; and
based on the updated real-time game data regarding the real-time odds and the real-time second odds, updating, by the processor, the odds for the parlay wager.
